(19) United States
(12) Patent Application Publication
(10) Pub. No.: US 2012/0084971 A1
(43) Pub. Date: Apr. 12, 2012

(54) DEVICE FOR MOUNTING ELECTRONIC PAPER DISPLAY ELEMENT

(75) Inventors: Young Woo LEE, Suwon (KR); Hwan-Soo Lee, Seoul (KR); Jung Min Park, Suwon (KR); Sang Moon Lee, Seoul (KR)

(73) Assignee: SAMSUNG ELECTRO-MECHANICS CO., LTD.

(21) Appl. No.: 13/163,078

(22) Filed: Jun. 17, 2011

(30) Foreign Application Priority Data
Oct. 11, 2010 (KR) 10-2010-0098781

(51) Int. Cl. B23P 19/00

(52) U.S. Cl. 29/822

(57) ABSTRACT

There is provided a device for mounting an electronic paper display element, the device including: a first roller formed to pass over a substrate in which display elements are to be mounted and mounting the display elements in the substrate by moving the display elements backwards, while moving in a predetermined direction above the substrate and rotating in the moving direction; and a second roller mounting the display elements in the substrate by rotating in a direction opposite to that of the first roller to move the display elements forward, while being disposed behind the first roller and moving in the same direction as that of the first roller.

### CROSS-REFERENCE TO RELATED APPLICATIONS

This application claims the priority of Korean Patent Application No. 10-2010-0098781 filed on Oct. 11, 2010 in the Korean Intellectual Property Office, the disclosure of which is incorporated herein by reference.

### BACKGROUND OF THE INVENTION

1. Field of the Invention

The present invention relates to a device for mounting an electronic paper display element, and more particularly, to a device for mounting an electronic paper display element capable of efficiently mounting an electronic paper display element in an electronic paper.

2. Description of the Related Art

Recently, changes to methods of transferring and sharing information have been required with the advent of an information society requiring a new paradigm. To this end, the technological development of flexible electronic paper as a flexible display has been accelerated and the technological development of electronic paper is nearing commercialization.

Electronic paper can be manufactured at lower cost than existing flat display panels, and does not require background lighting or continuous recharging like a regular screen, such that electronic paper can be driven with low energy expenditure while having excellent energy efficiency. In addition, the electronic paper is very clear, has a wide viewing angle, and has a memory function so as to maintain the display of characters even when power is not applied thereto.

Due to these advantages, electronic paper may be variously applied to a wide range of applications, such as an electronic book having a paper-like surface and moving illustrations, a renewable newspaper, a reusable paper display for a mobile phone, a disposable TV screen, electronic wallpaper, or the like, and has a huge potential market.

Technological approaches to implementing electronic paper may be classified into four types as follows: a twist ball type, rotating spherical particles formed of upper and lower hemispheres having different colors and electric charges opposed to each other and rotated by using an electric field, an electrophoresis type confining colored charged particles mixed with oil in micro capsules or micro-cups, and reacting the charged particles to an applied electric field, a quick response-liquid power display (QR-LPD) using charged jet fluids, and a cholesteric liquid crystal display type using selective reflection characteristics of cholesteric liquid crystal molecules.

the, The type using the twist ball generally has a structure in which twist balls, having different colors for each hemisphere, are disposed between two parallel transmitting sheets (hereinafter, referred to as an elastomer matrix) made of a material such as an elastomer.

The twist ball is manufactured of a resin material to a size of several hundred μm or less. In order to manufacture electronic paper having excellent contrast per a predetermined area, several thousand balls per 1 cm² are disposed in a substrate.

Therefore, various technologies for efficiently inserting the twist balls into the micro-cups at a desired position have been developed.

### SUMMARY OF THE INVENTION

An aspect of the present invention provides a device for mounting an electronic paper display element capable of efficiently mounting an electronic paper display element in a substrate by a simple manner while having a high insertion rate.

According to an aspect of the present invention, there is provided a device for mounting an electronic paper display element, the device including: a first roller formed to pass over a substrate in which display elements are to be mounted and mounting the display elements in the substrate by moving the display elements backwards, while moving in a predetermined direction abovethe substrate and rotating in the moving direction; and a second roller mounting the display elements in the substrate by rotating in an opposite direction to that of the first roller to move the display elements forwards, while being disposed behind the first roller and moving in the same direction as that of the first roller.

At least one of the first roller and the second roller may be a brush-type roller.

The device for mounting an electronic paper display element may further include an adsorption roller disposed in front of the first roller and removing foreign objects on the substrate prior to mounting the electronic paper display elements in the substrate while moving in the same direction as that of the first roller.

The adsorption roller may be connected with the first roller or the second roller by a belt to be rotated in the same direction as that of the first roller or the second roller.

The adsorption roller may be a brush-type roller.

The substrate may have micro-cups formed therein and the electronic paper display elements are mounted in the micro cups.

The the electronic paper display elements may be twist balls.

According to an aspect of the present invention, there is provided a method for mounting an electronic paper display element, the device including: a first roller formed to pass above a substrate in which display elements are to be mounted and mounting the display elements in the substrate while moving and rotating in a predetermined direction above the substrate; a first fluid supplying device formed in front of the first roller to move the display elements in the moving direction of the first roller; and a second fluid supplying device disposed behind the first roller to move the move the display elements in the moving direction of the first roller.

The first roller may be a brush-type roller.

The substrate may have micro-cups formed therein and the electronic paper display elements are mounted in the micro cups.

The the electronic paper display elements may be twist balls.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a device for mounting an electronic paper display element according to an exemplary embodiment of the present invention;

FIG. 2 is a cross-sectional view schematically showing a device for mounting an electronic paper display element according to another exemplary embodiment of the present invention; and

FIG. 3 is a cross-sectional view schematically showing a device for mounting an electronic paper display element according to another exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

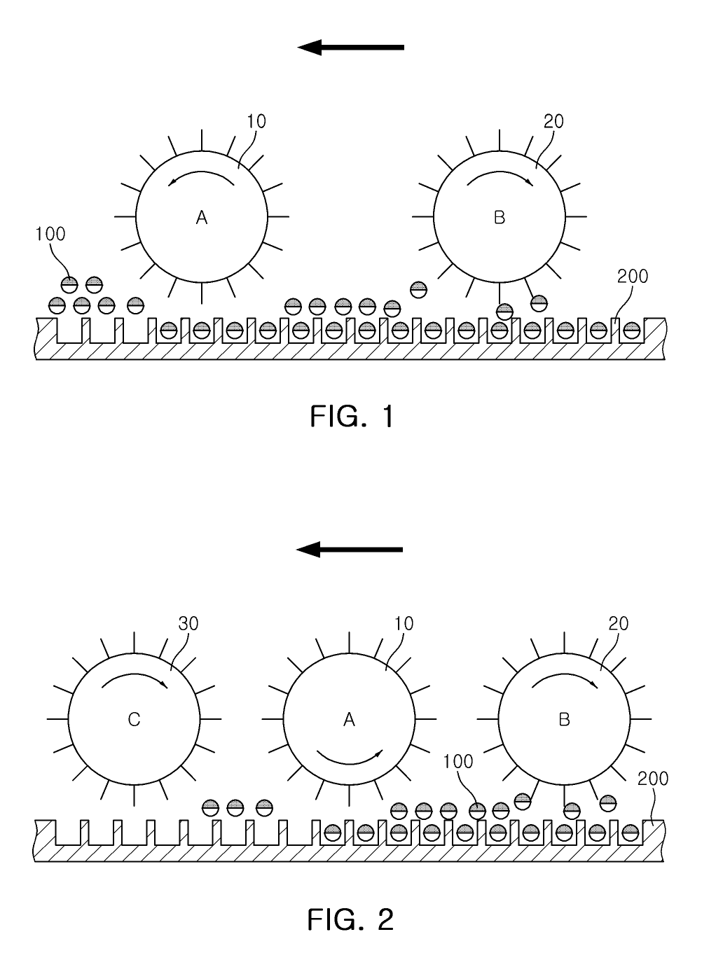

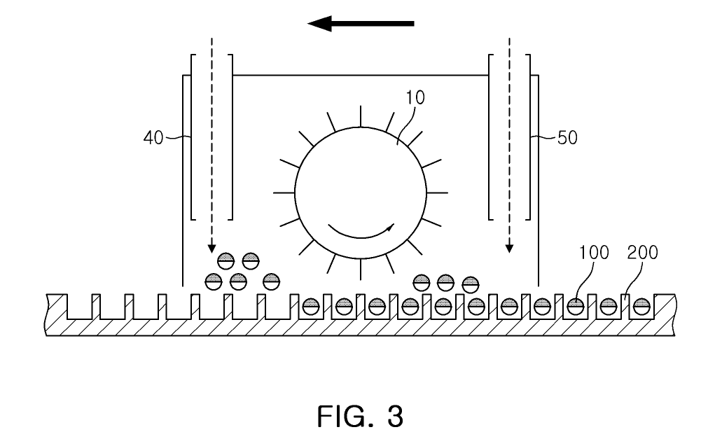

FIG. 1 is a cross-sectional view schematically showing a device for mounting an electronic paper display element according to an exemplary embodiment of the present invention, FIG. 2 is a cross-sectional view schematically showing a device for mounting an electronic paper display element according to another exemplary embodiment of the present invention, and FIG. 3 is a cross-sectional view schematically showing device for mounting an electronic paper display element according to another exemplary embodiment of the present invention.

Referring to FIG. 1, a device for mounting an electronic paper display element according to an exemplary embodiment of the present invention may be configured to include a first roller 10 formed to pass above a substrate 200 in which display elements 100 are to be mounted and mounting the display elements 100 in the substrate 200 by moving the display elements 100 backwards, while moving in a predetermined direction above the substrate 200 and rotating in the moving direction; and a second roller 20 mounting the display elements 100 in the substrate 200 by rotating in a direction opposite to that of the first roller to move the display elements 100 forward, while being disposed behind the first roller 10 and moving in the same direction as that of the first roller 10.

The first roller 10 and the second roller 20 are rotated in opposite directions to each other, such that the display elements 100 are collected inside the two rollers. In this manner, the display elements 100 are mounted in the micro-cups formed in the substrate 200 while not being scattered on the substrate 200.

Referring to FIG. 1, the first roller 10 according to an exemplary embodiment of the present invention pushes the display elements 100 backwards, while being rotated in the same direction as the moving direction to mount the display elements 100 in the substrate 200. That is, the first roller 10 fills the display elements 100 in the micro-cups while being rotated, and pushes the remaining display elements 100 backwards in the moving direction thereof.

Therefore, the first roller 10 is formed to move forward in a predetermined direction, such that the first roller 10 mounts the display elements 100 over the substrate 200 while passing above the substrate 200.

The second roller 20 is disposed behind the first roller 10 in the moving direction of the first roller 10, and moves in the same direction as that of the first roller 10. Therefore, the second roller 20 serves to fill the micro-cups in the substrate 200 with the remaining display elements that have not been filled by the first roller 10.

The second roller 20 serves to push the remaining display elements 100, which have not been filled in the micro-cups by the first roller 10, forwards, by rotating in a direction opposite to that of the first roller 10 in order to collect the display elements 100, and serves to fill the remaining display elements, which have not been filled by the first roller 10, in the micro-cups.

In addition, the second roller 20 serves to remove the display elements 100, which have not been mounted in the micro-cups, so that post-processing is not disturbed. That is, the second roller 20 pushes the remaining display elements 100 forward, such that the electronic paper display elements do not remain in a position through which the second roller has passed. Therefore, residual display elements do not remain on the substrate 200 across which the first roller 10 and the second roller 20 pass.

In addition, at least one of the first roller 10 and the second roller 20 may be a brush-type roller; however, the present invention is not limited thereto, and may attach the display elements 100 to the roller by an electrostatic force to mount the display elements in the substrate 200. In this case, since an attraction force generated by a fluid disposed in the micro-cups formed in the substrate is larger than the electrostatic force, the display elements are mounted in the substrate.

That is, the first and second rollers serve to remove residual display elements 100, which have not been filled in the substrate, while mounting the display elements 100 in the substrate 200 by passing the first roller 10 and the second roller 20 above the substrate 200 without a separate process.

Referring to FIG. 2, showing a device for mounting an electronic paper display element according to another exemplary embodiment of the present invention, the first roller 10 and the second roller 20 may be included, and an adsorption roller 30 may be further provided.

When the first roller 10 fills the display elements 100 in the micro-cups in the substrate 200 while the first roller 10 and the second roller 20 rotate in an opposite direction to each other, the second roller 20 serves to fill the display elements 100, which have not been filled by the first roller 10, in the micro-cups, while collecting the remaining display elements 100, which have not been filled by the first roller 10.

According to another exemplary embodiment of the present invention, the adsorption roller 30 may be further included, removing foreign objects remaining on the substrate 200 prior to mounting the display elements 100 in the micro-cups while being disposed in front of the first roller 10 and moving in the same direction thereof.

The adsorption roller 30 is disposed in front of the first roller 10 in the moving direction of the first roller 10. The adsorption roller 30 serves to remove foreign objects, such as dust remaining on the substrate 200, before the first roller 10 moves.

According to the exemplary embodiment of the present invention, the adsorption roller 30 is connected with the first roller 10 or the second roller 20 by a belt, to be rotated in the same direction as that of the first roller 10 or the second roller 20.

Referring to FIG. 2, the adsorption roller 30 may be connected with the second roller 20, and may be rotated in the same direction as that of the second roller 20. Therefore, the second roller 20 and the adsorption roller 30 may be rotated in the same direction while moving in the same direction.

According to an exemplary embodiment of the present invention, the adsorption roller 30 may be a roller formed to adsorb foreign objects such as dust, or the like, on the surface of the substrate. Preferably, the adsorption roller 30, which is an adsorption brush, may remove foreign objects formed on the surface of the substrate 200 by an electrostatic method or a method using an adhesive material.

According to an exemplary embodiment of the present invention, the micro-cups may be formed in the substrate 200. That is, the micro-cups having a micro size may be used to mount the electronic paper display elements according to an exemplary embodiment of the present invention.

The device for mounting an electronic paper display element according to an exemplary embodiment of the present invention may be used for various types of electronic paper display element. However, according to an exemplary embodiment of the present invention, the device for mounting an electronic paper display element may be used to mount a twist ball type of the electronic paper display element.

According to an exemplary embodiment of the present invention, at least one selected from a group consisting of the first roller 10, the second roller 20, and the adsorption roller 30 may be a brush-type roller.

The first roller 10, the second roller 20, and the adsorption roller 30, which are a brush-type roller, may be used to mount the display elements 100 in individual micro cells for mounting display elements 100, such as in the micro-cups formed in the substrate 200.

According to an exemplary embodiment of the present invention, the individual display elements 100 may be mounted in each of micro cells formed in the substrate while using the brush-type roller for mounting the electronic paper display elements in the micro-cups.

In addition, the first roller 10 and the second roller 20 are rotated in an opposite direction to each other to fill the display elements 100 in the cells in the substrate 200 while confining the display element 100 between the first roller and the second roller, thereby making it possible to completely fill the display elements 100 in the substrate 200.

Since the second roller passes above the substrate 200 while pushing the display elements forward, without separate post-processes, such that the residual display elements do not remain on the substrate when the first and second rollers pass above the substrate 200 while filling the display elements 100 in the substrate 200. That is, the residual display elements may be filled in the substrate, thereby being removed. The display elements 100 may be uniformly mounted over the substrate 200 by a simple manner and the residual display elements that have not been filled in the substrate may be easily removed.

Referring to FIG. 3, a device for mounting an electronic paper display element according to another exemplary embodiment of the present invention may be configured to include the first roller 10, formed to pass above a substrate 200 in which display elements 100 are to be mounted and mounting the display elements 100 in the substrate 200 while moving and rotating in a predetermined direction above the substrate 200, a first fluid supplying device 40 formed in front of the first roller 10 to move the display elements 100 in the moving direction of the first roller 10; and a second fluid supplying device 50 disposed behind the first roller 10 to move the display elements 100 in the moving direction of the first roller 10.

Referring to FIGS. 1 and 2, through the movement of the two rollers, the display elements 100 are collected in the substrate 200, between the first roller 10 and the second roller 20, to fill the micro-cups.

Referring to FIG. 3, the display elements 100 may be collected at a position by using the first fluid supplying device 40 and the second fluid supplying device 50 rather than collecting the display elements 100 by moving the first roller 10 and the second roller 20.

Therefore, the display elements 100 may be first filled at the position in which the display elements 100 are collected and may be filled over the entire area of the substrate 200 while the first fluid supplying device 40, the first roller 10, and the second fluid supplying device 50 move in the same direction together.

According to an exemplary embodiment of the present invention, the first fluid supplying device 40 and the second fluid supplying device 50 may collect the electronic paper display elements 100 at a position by a gas supplying method.

According to an exemplary embodiment of the present invention, the first fluid supplying device 40 is formed in front of the first roller 10 to supply gas, thereby making it possible to collect the electronic paper display elements in front of the first roller. Therefore, the first roller 10 may mount the display elements 100 supplied by the first fluid supplying device 40 in the micro-cups formed in the substrate 200, while being rotated.

Further, the second fluid supplying device 50 is formed behind the first roller 10 to move the display elements 100 to the backward of the first roller 10 by the gas supplying method. Therefore, when the first roller 10 is rotated, the display elements 100 supplied by the second fluid supplying device 50 is mounted in the micro-cup formed in the substrate 200.

The second fluid supplying device 50, which also serves to remove the display elements 100 that have not been mounted in the substrate 200, may serve to remove the residual display elements 100 remaining on the substrate 200 while mounting the electronic paper display elements in the substrate so that separate processes are not required.

According to an exemplary embodiment of the present invention, the first roller 10 may be a brush-type roller and may mount the electronic paper display elements in the micro-cups formed on the substrate 200 by the brush-type roller.

In the exemplary embodiments of the present invention, various types of electronic paper display elements may be mounted in the substrate 200. According to an exemplary embodiment of the present invention the display elements 100 may be a twist ball and the twist balls may be filled in the micro cells formed in the substrate 200.

According to the exemplary embodiment of the present invention, the electronic paper display elements may be effectively mounted in the micro-cups formed in the substrate 200 by the simple manner. The display elements 100 may be uniformly and completely filled in the micro-cups at a fast speed, without any omission. In addition, the display elements 100, which have not been mounted in the micro-cups, can be removed in a simple manner so that the post-processes are not disturbed.

According to the exemplary embodiments of the present invention, the display elements 100 can be mounted in the substrate 100 in such a manner as to not form the residual display elements in the substrate 200 while increasing the mounting efficiency of the display elements in the substrate 200 by the rotation of the first roller 10 and the second roller 20 rotating in an opposite direction to each other or by the air pressure of the first fluid supplying device 40 and the second fluid supplying device 50.

As set forth above, according to the exemplary embodiments of the present invention, there is provided the device for mounting an electronic paper display element capable of simply mounting twist balls in the substrate for the electronic paper.

While the present invention has been shown and described in connection with the exemplary embodiments, it will be apparent to those skilled in the art that modifications and variations can be made without departing from the spirit and scope of the invention as defined by the appended claims.

What is claimed is:

1. A device for mounting an electronic paper display element, the device comprising:
a first roller formed to pass over a substrate in which display elements are to be mounted and mounting the display elements in the substrate by moving the display elements backwards, while moving in a predetermined direction above the substrate and rotating in the moving direction; and
a second roller mounting the display elements in the substrate by rotating in an opposite direction to that of the first roller to move the display elements forwards, while being disposed behind the first roller and moving in the same direction as that of the first roller.

2. The device of claim 1, wherein at least one of the first roller and the second roller is a brush-type roller.

3. The device of claim 1, further comprising an adsorption roller disposed in front of the first roller and removing foreign objects on the substrate prior to mounting the electronic paper display elements in the substrate while moving in the same direction as that of the first roller.

4. The device of claim 3, wherein the adsorption roller is connected with the first roller or the second roller b ya belt to be rotated in the same direction as that of the first roller or the second roller.

5. The device of claim 3, wherein the adsorption roller is a brush-type roller.

6. The device of claim 1, wherein the substrate has micro-cups formed therein and the electronic paper display elements are mounted in the micro cups.

7. The device of claim 1, wherein the electronic paper display elements are twist balls.

8. A device for mounting an electronic paper display element, the device comprising:
a first roller formed to pass above a substrate in which display elements are to be mounted and mounting the display elements in the substrate while moving and rotating in a predetermined direction above the substrate;
a first fluid supplying device formed in front of the first roller to move the display elements in the moving direction of the first roller; and
a second fluid supplying device disposed behind the first roller to move the move the display elements in the moving direction of the first roller.

9. The device of claim 8, wherein the first roller is a brush-type roller.

10. The device of claim 8, wherein the substrate has micro-cups formed therein and the electronic paper display elements are mounted in the micro cups.

11. The device of claim 8, wherein the electronic paper display elements are twist balls.
